(19) United States
(12) Patent Application Publication
(10) Pub. No.: US 2012/0304474 A1
(43) Pub. Date: Dec. 6, 2012

(54) Splitting Implement

(76) Inventor: James MOORE, Unionville, MI (US)

(21) Appl. No.: 13/485,489

(22) Filed: May 31, 2012

Related U.S. Application Data
(60) Provisional application No. 61/519,790, filed on May 31, 2011.

(51) Int. Cl. B26B 23/00

(52) U.S. Cl. 30/308.1

(57) ABSTRACT

A splitting implement comprises a first head member, a second head member attached thereto, and a handle on which the first head member is disposed. The first head member is configured for splitting a surface or an object, and the second head member may be similarly configured, except that the second head member is of such dimensions that it does not strike the object or surface until after the first head member strikes the object or surface. The second head member may assist the first head member in penetrating the surface or object and in splitting the surface or object. In the event that the splitting implement becomes embedded in the surface or object, the second head member may increase the leverage that the splitting implement may exert for extracting the splitting implement from the surface or object.

### CROSS-REFERENCE TO RELATED APPLICATIONS

The present disclosure claims priority under 35 United States Code, Section 119 on the U.S. Provisional Patent Application No. 61/519,790, filed on May 31, 2011, the disclosure of which is incorporated by reference.

### FIELD

The present disclosure relates to tools for splitting, such as a axe or maul that may be used to chop or split wood or logs, and more particularly, to a splitting implement that may reduce the risk damage to the implement that may occur while using the implement and that may more efficiently accomplish splitting of an object.

### BACKGROUND

Striking implements, such as axes or mauls that include a head (for striking an object) and handle, have been available for years. A typical implement includes a handle made of hardwood. The axe or maul head is attached directly to the handle, and the head is configured to pierce or split an object when the user swings the head and brings it into contact with the object. Prior art designs, while simple, suffer from certain drawbacks.

For instance, if the head of the striking implement misses the object such that the handle of the implement instead strikes the object, the handle may crack or break due to the vibrational force imparted on the handle. Accordingly, what is desired is to provide a simple, cost efficient device which, when attached to or incorporated on the head of a striking implement, increases the lifetime of the striking implement by protecting the handle from such damage. Prior art inventions have attempted to solve this problem by fortifying the area below the point of connection between the handle and the head member, as shown in U.S. Pat. No. 7,181,994, for example.

Another drawback in the prior art relates to the relatively narrower head of a maul (as compared to an axe head, for instance.) Such a narrower head does not allow the user to exert much leverage or twisting force through the handle once the head has embedded in a split object following a swing and impact of the implement. What is desired is to provide a simple, low-cost device which, when attached to or incorporated on such a relatively narrow head, increases the available leverage that the user can exert upon the head when the head is embedded in an object, thereby facilitating another means of splitting of the object, namely, through such leverage/twisting forces.

The head of prior art axes and mauls tend to get “stuck” or tightly wedged into the object if the strike does not produce a sufficiently full split. For example, the relatively broad, thin, sharp blade of an axe tends to slice and drive deeply into the end-grain of a wood log when a user is attempting to chop and split the log. If a strike does not result in a sufficiently full split of the wood, the head often winds up tightly wedged in the log as a result of the strike's depth and the lateral pressure and the resulting friction of the wood against the relatively broad face surfaces of the axe head, making extraction of the head more difficult and time-consuming.

Similarly, a heavier, thicker and more angular maul drives deeply into such material, albeit with less face surface face area than that of a typical axe head, but with a much more exaggerated and pronounced resulting split. If a strike does not result in a sufficiently full split of the wood, the maul head also often winds up tightly wedged in the log as a result of the strike depth, the lateral pressure, and resulting friction of the wood against the surface faces of the maul due to the greater angular split. What is desired is to provide a simple, cost efficient device which, when attached to the head, decreases the force required to extract the head of a maul or axe from an object in those situations where a strike does not result in a sufficiently full split of the object. Certain prior art efforts have been devised to alter the shape head of mauls and axes, either through reconfigurations of the overall shape or through various mechanically actuated/moving components. These tend to be either overly complex, subject to mechanical frailty or failure, or simply do not provide a meaningfully sufficient resolution to the problem.

### SUMMARY OF THE DISCLOSURE

In view of the foregoing disadvantages of the prior art, an improved splitting implement is provided. The implement includes a device that is coupled to the head of a splitting implement, such as an axe or maul, which device may reduce the impact force on the handle of the implement in the event of missed strikes or mishits of the implement on or near a target and) make extraction of the head of the implement from the target object easier.

In an embodiment, the present disclosure comprises a splitting implement with a first member”) in the shape and configuration of an axe or maul, which head member is connected to a handle. The head member is preferably configured with a front edge that is distal from the handle, which front edge is pointed or tapered, with upper and lower edges that lead back from the front edge that is distal to the handle, and a rear edge opposite the front edge that is generally proximate to the handle connection point. The front and rear edges are substantially parallel to the length of the handle, and the upper and lower edges generally are perpendicular to the length of the handle. The disclosure further comprises a second head member The second head member may be configured and disposed in substantially similar dimensions and positioning as the first head member, except that the dimensions of the second head member are preferably smaller than the dimensions of the first head member. In an embodiment where the first head member comprises an axe-like configuration, the second head member may comprise a rear edge with a dimension that is wider at its portion that is distal to the first head member than the width of its rear edge that is proximate to the first head member.

In an embodiment, the second head member may be attached to or formed as a part of the first head member, with the second head member preferably being disposed along the bottom edge of first head member at a location that is between the handle and the front edge of the first head member. In another embodiment, the second head member may be attached to or formed as a part of the first head member along the top edge of the first head member such that the bottom edge of the second head member attaches to or is formed integral with the top edge of the first head member.

The front (leading) edge of the first head member may penetrate an object when the user brings the first head member of the splitting implement into contact with the object that a user desires to split. When the splitting implement so comes into contact with an object, the first head member begins to split the object. The second head member thereafter also strikes the object and assists in splitting the object by also penetrating the object. For example, the second head member may increase in size of the split in the object and thereby diminish the pressure and friction that the split object otherwise exerts on the first head member. This decreased pressure and friction allows the first head member to be extracted by the user from the object more easily than if the secondary head member were not present.

In an embodiment wherein the first head member comprises a maul or an axe head, for example, the increased combined overall length of the first and second head members allows the user to exert greater leverage, or twisting or prying force upon the implement once it is embedded in a split of an object, thereby better allowing the user to enlarge the split as desired.

The second head member may preferably be cast as part of the first head member as an integral unit, although the second member may also be welded to or otherwise attached to the first head portion member to allow a retrofitting of the second head member to an existing prior art implement. Furthermore, the second head member may comprise at least one relatively sharp edge for further assisting in the splitting of an object.

These together with other aspects of the present disclosure, along with the various features of novelty that characterize the present disclosure, are pointed out with particularity in the claims annexed hereto and form a part of this present disclosure. For a better understanding of the present disclosure, its operating advantages, and the specific objects attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 shows a perspective view of a splitting implement, in accordance with an exemplary embodiment of the present disclosure;

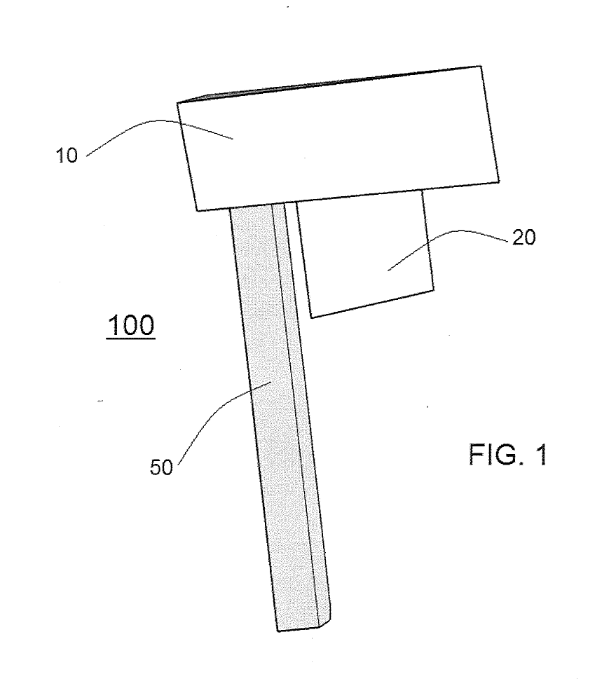

FIG. 2 shows another perspective view of a splitting implement, in accordance with another exemplary embodiment of the present disclosure; and

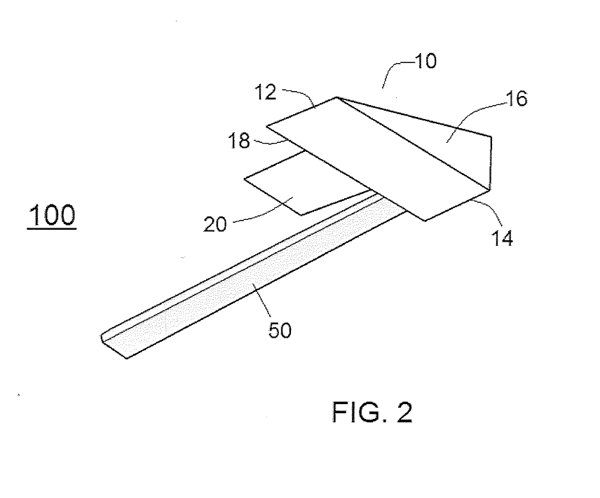

FIG. 3 shows a perspective view of a first head member and a second head member of a splitting implement, in accordance with an exemplary embodiment of the present disclosure.

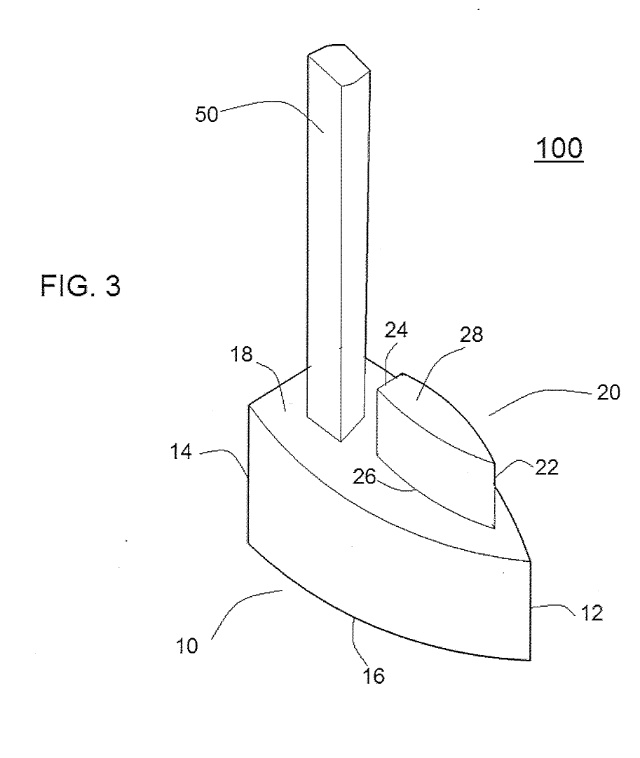

Like reference numerals refer to like parts throughout the description of several views of the drawings.

### DETAILED DESCRIPTION

The best mode for carrying out the present disclosure is presented in terms of its preferred embodiment, herein depicted in the accompanying figures. The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure.

Unless limited otherwise, the terms “disposed,” “coupled,” “attached,” and variations thereof herein are used broadly and encompass direct and indirect arrangements. The term “top,” “bottom,” “front,” “back,” “first,” “second,” and the like, herein do not denote any order, elevation or importance, but rather are used to distinguish placement of one element over another. The terms “a” and “an” herein do not denote a limitation of quantity, but rather denote the presence of at least one of the referenced items.

The present disclosure comprises a splitting implement 100. The implement comprises a first head member 10, a second head member 20, and a handle 50. The first head member 10 is coupled to the handle 50, and the second head member 20 is coupled to the first head member 10. In an embodiment, the second head member 20 may also be coupled to the handle 50.

The handle 50 may be formed from hardwood, lightweight metal, or any other material that provides sufficient rigidity and resiliency for swinging with a head member or members attached thereto and for impacting an object.

The first head member 10 is attached to the handle 50 via any known mechanism that provides for secure attachment of the first head member 10 to the handle 50 that provides sufficiently secure attachment of the first head member 10 such that the first head member 10 remains attached to the handle when the implement is swung or manipulated and when the implement (whether the first head member 10 or handle 50 thereof) comes into contact with an object. In an embodiment the first head member 10 may include an aperture through which the handle 50 is received, for attaching the first head member 10 and the handle 50 to one another. The handle 50 is preferably an elongated shaft in configuration, and the first head member 10 is preferably attached to the handle 50 at an end of the handle 50.

The first head member 10 comprises a front edge 12, a rear edge 14, a top edge 16, and a bottom edge 18. The front edge 12 of the first head member 10 is distal to the handle 50, and the rear edge 14 is proximate to the handle 50. The front edge 12 and rear edge 14 are preferably substantially parallel to one another and to the handle 50. The front edge 12 preferably includes a taper such that the front edge 12 may form a narrow face, which narrow face may better pierce a the surface of an object for facilitating splitting the object when the implement 100 comes into contact with the object during use thereof. The first head member 10 may also comprise a wedge shape with the front edge 12 comprising a comparatively narrower width than the rear edge 14, having a comparatively greater width.

The second head member 20 comprises a front edge 22, a rear edge 24, a top edge 26 and a bottom edge 28. The front edge 22 of the second head member 20 is distal to the handle 50, and the rear edge 24 is proximate to the handle 50. The front edge 22 and rear edge 24 are preferably substantially parallel to one another and to the handle 50. At least one of the front edge 22, rear edge 24, top edge 26 and bottom edge 28 may comprise a edge of sufficient sharpness to facilitate cutting or splitting an object. The second head member 20 preferably may attach to the top edge 16 of the first head member 10 or to the bottom edge 18 of the first head member 10. Particularly, the bottom edge 28 of the second head member 20 may attach to the top edge 16 of the first head member to dispose the second head member 20 on the first head member 10 and away from the handle 50. Alternatively, the top edge 26 of the second head member 20 may attach to the bottom edge 18 of the first head member 10.

The length of the top edge 26 and bottom edge 28 of the second head member 20 may be shorter than the length of the top edge 16 and bottom edge 18 of the second head member 10. The second head member 20 may be disposed on the first head member so that the second head member is immediately adjacent to the handle 50, or spaced a distance away from the handle 50. Preferably, the front edge 12 of the first head member 10 will contact an object before the front edge 22 of the second head member 20 contacts the same object or surface when the implement 100 is brought into contact with the object or surface. With regard to the attachment of the second head member 20 to the first head member 10, the second head member 20 may be integral to the first head member 10, or it may be attached after the first head member 10 is manufactured, by way of a weld, for example. In the latter embodiment, it will be apparent that the present disclosure may be accomplished as a retrofit to an existing splitting implement.

In an embodiment, the width of the second head member 20 (from front edge 22 to rear edge 24) may be less than the width of the first head member (from front edge 12 and rear edge 14), such that the second head member 20 does not extend outside of the dimensions of the first head member 10. In another embodiment, the width of the second head member at the rear edge 24 may exceed the width of the second head member at the front edge 22 such that the configuration of the second head member may flare outwardly measured from the front edge 22 to the rear edge 24. In a further embodiment, the width of the rear edge 22 of the second head member may exceed the width of the first head member 10 at the point at which the rear edge 22 is disposed against the first head member 10, such that at least a portion of the second head member extends past a portion of the first head member 10.

The splitting implement of the present disclosure offers the following advantages: it provides a cost-effective means for minimizing the force of impact transmitted through the handle of a splitting implement when the implement or handle thereof strikes an object. This minimization of force increases ergonomics of the implement for the user and also reduces damage to or breaking of the handle. Further the splitting implement disclosed herein facilitates splitting of an object and easier removal of the implement from an object after the striking of the object did not result in an effective splitting of the object

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

1. A splitting implement comprising:
a first head member, a second head member, and a handle,
wherein said first head member comprises a front edge and a rear edge, which front edge and rear edge are substantially parallel to the handle of the implement, and which front edge is distal to the handle and which rear edge is proximate to the handle,
wherein said second head member comprises a front edge and a rear edge, which front edge and rear edge are substantially parallel to the handle of the implement, and which front edge is distal to the handle and which rear edge is proximate to the handle,
wherein said first head member is attached to an end of the handle,
wherein said second head member is attached to said first head member,
and wherein, when the splitting implement manipulated by the handle thereof such that the first head member strikes an object, said second head strikes the object after the first head member.

2. The splitting implement of claim 1, wherein the width of the second head member at the rear edge thereof exceeds the width of the second head member at the front edge thereof such that the configuration of the second head member may flare outwardly

3. The splitting implement of claim 2, wherein the width of the rear edge of the second head member may exceed the width of the first head member at the point at which the rear edge of the second head member is disposed against the first head member.

4. The splitting implement of claim 1, wherein the first head member is an axe.

5. The splitting implement of claim 1, wherein the first head member is a maul.

6. The splitting implement of claim 1, wherein the second head member is disposed on an edge of the first head member that is distal to the handle.

7. The splitting implement of claim 1, wherein the second head member is disposed on an edge of the first head member that is proximate to the handle.

8. A splitting implement comprising:
a first head member, a second head member, and a handle,
wherein said first head member comprises a front edge and a rear edge, which front edge and rear edge are substantially parallel to the handle of the implement, and which front edge is distal to the handle and which rear edge is proximate to the handle,
wherein said second head member comprises a front edge and a rear edge, which front edge and rear edge are substantially parallel to the handle of the implement, and which front edge is distal to the handle and which rear edge is proximate to the handle,
wherein said first head member is attached to an end of the handle,
wherein said second head member is attached to said first head member,
and wherein said second head member is smaller than said first head member.

9. The splitting implement of claim 8, wherein the width of the second head member at the rear edge thereof exceeds the width of the second head member at the front edge thereof such that the configuration of the second head member may flare outwardly

10. The splitting implement of claim 8, wherein the first head member is an axe.

11. The splitting implement of claim 8, wherein the first head member is a maul.

12. The splitting implement of claim 8, wherein the second head member is disposed on an edge of the first head member that is distal to the handle.

13. The splitting implement of claim 8, wherein the second head member is disposed on an edge of the first head member that is proximate to the handle.
